(19) United States
(12) Patent Application Publication
(10) Pub. No.: US 2023/0015521 A1
(43) Pub. Date: Jan. 19, 2023

(54) LIGHT-TRANSMITTING METAL PANEL WITH MICRO MATRIX PATTERN AND A LIGHT-EMITTING DEVICE THEREOF

(71) Applicant: HON YU AUTO PARTS CO., LTD., New Taipei City (TW)

(72) Inventor: Yin-Teng HSIAO, New Taipei City (TW)

(21) Appl. No.: 17/535,554

(22) Filed: Nov. 24, 2021

(30) Foreign Application Priority Data
Jul. 9, 2021 (TW) 110125343

(51) Int. Cl. F21V 11/14

(52) U.S. Cl. CPC F21V 11/14

(57) ABSTRACT

The present application discloses a light-transmitting metal panel with micro matrix pattern, including a light-transmitting micro matrix pattern penetrating from thin metal plate, is provided. Based on the relative relationship among the thickness of a thin metal plate, the aperture of the micropores, and the spacing distance of the micropores, the light-transmitting metal panel with micro matrix pattern is suitable for applied as many kinds of decorative light-transmitting panel. Moreover, it is achieved that the presence of micropores on the metal surface is not easily noticeable, the static moisture is not easy to penetrate through the thin metal panel, and each light penetrating through one of the micropores can be merged with lights penetrating through adjacent micropores to visually diffused and combined into a flat light pattern when it is configured with the backlight module for light transmission.

### BACKGROUND

### Technical Field

The present disclosure relates to the field of light-transmitting metal panel, and more particular to a light-transmitting micro matrix pattern penetrating through a thin metal plate, having micropores difficult to recognize the presence of the naked eye and impermeable, and each light penetrating through the micropore can be merged with lights penetrating from the adjacent micropores to form visually flat lights when it is configured with the backlight module for light transmission.

### Description of Related Art

The production process of micro-holes in metal plates generally includes punching with molds, drilling with laser light, and etching with chemical liquids. The resulting microporous metal plates are mainly used to filter gaseous or liquid fluids, such as filter residues, Oil filter, etc. by using the above-mentioned etching technology.

This kind of micropores could be so small that it is difficult to recognize the presence of the naked eye, for example, a micropore can be smaller than 0.1 mm on a metal plate.

Moreover, if the water droplets do not be exerted external force on this kind of micropores, for example, micropores smaller than 0 7 mm on the metal plate, due to the cohesion of water molecules and the effect of surface tension, the water will not pass through this kind of micropores. If the smaller the moisture is, the less likely it is to penetrate.

In addition, if the micropores with this size are arranged in a matrix on the metal sheet into a pattern, and then forces the light of the backlight module to penetrate these micro-holes, when the light passes through each micropores from the bottom, it radiates on the surface. The divergence of its light and the degree of fusion between lights will also determine whether the matrix of point light will be visually regarded as the pattern shape of flat light.

### SUMMARY

In view of above, the present application is to provide a light-transmitting metal panel with micro matrix pattern, including a light-transmitting micro matrix pattern penetrating through a thin metal plate. Based on the relative relationship among the thickness of the thin metal plate, the aperture of the micropores, and the spacing distance of the micropores, the below purposes are able to be reached:

1.By defining the aperture of the micropores on the thin metal panel, the presence of perforations on the metal surface is not easily noticeable.

2.By defining the aperture of the micropores on the thin metal plate, the static moisture is not easy to penetrate through the thin metal panel.

3. By defining the aperture of the micropores and the spacing of the micropores on the thin metal panel, when the backlight penetrate through the thin metal panel, each light spot can be visually diffused and combined into a flat light pattern.

According to the definition of the present application, a light-transmitting metal plate of the microporous matrix can be used to make various decorations, such as various luminous decorations.

Accordingly, the present application is to provide a light-transmitting metal panel with micropores matrix for adopting the above purposes, including light-transmitting micro matrix pattern penetrating through a thin metal plate. The micro matrix pattern is formed by configuring a plurality of micropores penetrating through the thin metal plate. Based on the relative relationship among the thickness of the thin metal plate, the aperture of the micropores, and the spacing distance of the micropores, and more precisely, based on the relative relationship among the aperture of the micropore X, the spacing distance of the micropore Y, the thickness of the thin metal plate Z, it is achieved that the presence of micropores on the metal surface is not easily noticeable, the static moisture is not easy to penetrate through the thin metal panel, and each light spot can be visually diffused and combined into a flat light pattern according to the special definition of the spacing distance.

In the present application, the relative relationship values of the thickness Z of the thin metal plate, the aperture X of the micropores, and the spacing distance Y of the micropores are defined as shown in the following table:

| Z | X | Y |
|---|---|---|
| 0.1 mm | 0.05~0.15 mm | 0.1~0.15 mm |
| 0.2 mm | 0.15~0.25 mm | 0.2~0.25 mm |
| 0.3 mm | 0.25~0.35 mm | 0.3~0.35 mm |
| 0.4 mm | 0.35~0.45 mm | 0.4~0.45 mm |
| 0.5 mm | 0.45~0.55 mm | 0.5~0.55 mm |
| 0.6 mm | 0.55~0.65 mm | 0.6~0.65 mm |

In the present invention, the micropore configured on the thin metal plate can also be an inverted cone-shaped pore with a bottom diameter larger than the surface diameter. In practice, the preferred ratio of the surface diameter and the bottom diameter of the micropore is between 1. : 1.5-2.

In the present application, the shapes of micropores on the thin metal plate are selected from any one of a round hole, a polygonal hole or a special-shaped hole.

In addition, the present application is able to be applied to a light-emitting device, combining a light-transmitting metal panel with a microporous plane on the light-emitting surface of a backlight module, as a light-transmitting decoration of the light-emitting body.

The detailed features and advantages of the present invention will be described in detail in the following embodiments, and the content is sufficient to enable anyone familiar with the relevant art to understand the technical content of the present invention and implement it accordingly, and according to the content disclosed in this specification and the scope of patent application With the drawings, anyone who is familiar with the relevant art can easily understand the purpose and advantages of the present invention.

### BRIEF DESCRIPTION OF THE DRAWINGS

FIG. 1 is a plan view of the appearance of the first embodiment of a light-transmitting metal panel with micro matrix pattern according to the present application;

FIG. 2 is the size diagram of the microporous matrix of the first embodiment according to the present application;

FIG. 3 is a cross-sectional view of the first embodiment of the present invention;

FIG. 4 is cross-sectional view of a simulated water drop in the first embodiment according to the present application;

FIG. 5 is a cross-sectional view of the first embodiment of the present invention that simulates light penetration;

FIG. 6 is a cross-sectional view of the second embodiment of the transparent metal panel with a microporous matrix of the present invention;

FIG. 7 is a cross-sectional view of the second embodiment of the present invention that simulates light penetration;

FIG. 8 a schematic diagram of the dark area comparison between the first embodiment and the second embodiment of the present invention.

### DESCRIPTION OF THE EMBODIMENTS

It should be noted that when an element is referred to as being “fixed to” another element, it can be directly on the other element or a central element may also exist. When an element is considered to be “connected” to another element, it can be directly connected to the other element or an intermediate element may also exist. The terms “vertical”, “horizontal”, “left”, “right” and similar expressions used herein are for illustrative purposes only, and do not mean it is the only implementation.

Unless otherwise defined, all technical and scientific terms used herein have the same meaning as commonly understood by those skilled in the technical field of the present invention. The terms used in the specification of the present invention herein are only for the purpose of describing specific embodiments and are not intended to limit the present invention. The term “and/or” as used herein includes any and all combinations of one or more related listed items.

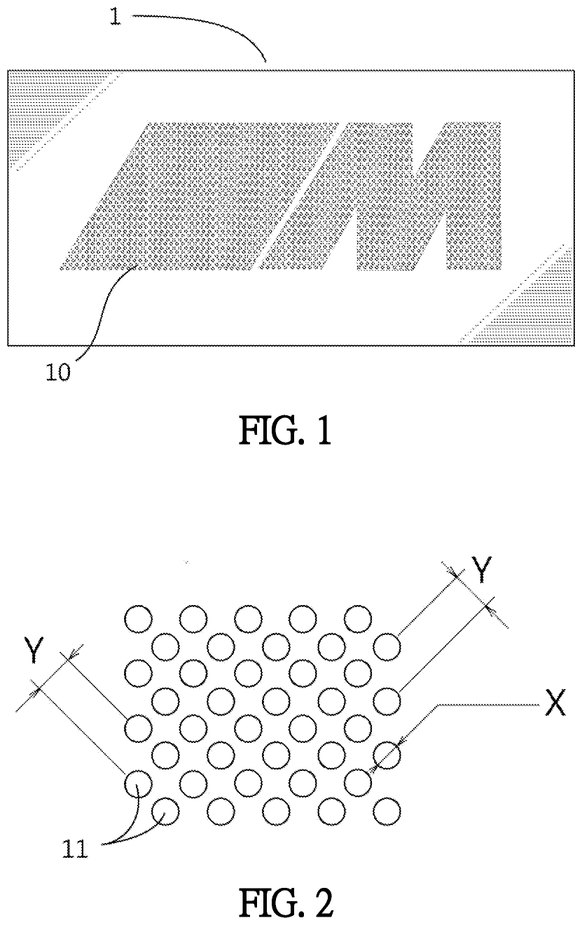

Please refers to FIG. 1 to FIG. 3, a plan view, a dimensional view and a cross-sectional view of the appearance of the first embodiment of the light-transmitting metal panel with micro matrix pattern of the present application are provided. In one embodiment of the present application, a plurality of penetrating micropores 11 is configured at a thin metal plane 1, and at least one micropores matrix patterns 10 is formed by the arrangement of a matrix of the penetrating micropores, in which shapes of the penetrating micropores 11 of the thin metal plate 1 are able to be selected from a round hole, a polygonal hole or a special-shaped hole.

An aperture X and a spacing distance Y of the micropores matrix patterns 10 formed by micropores and defined by the present application are able to meet the below three requirements:

1. It is not easy to notice the existence of a single micropore 11 from one meter away, and the micropores matrix pattern 10 also seems to form as a metal surface with a different texture.

2. When the water droplets are dropped on the thin metal plate 1 with micropores 11, the water droplets cannot penetrate through the thin metal plate 1 naturally; and

3. By configuring a backlight module on the bottom of the micropores matrix pattern 10, from the view of the surface of the micropores matrix pattern 10, the light emitted from each micropore 11 merges with each other due to the diffusion effect of light, so that it is difficult to recognize the existence of the aperture and is easy to visually express the combination of the light emitted from each micropore as a flat light.

Please refer to FIG. 4, when water drops W are dropped on the micropores matrix pattern 10 configured by the plurality of micropores 11 on the thin metal plate 1, because the size of the micropores 11 is set below 0.65 mm in this embodiment, the water droplets W is therefore not able to naturally penetrate through the thin metal plate 1 from the micropores 11.

As shown in FIG. 5, the present application is applied to a light-emitting device in this embodiment, by combining a light-transmitting metal panel with a microporous matrix on the light-emitting surface of a backlight module 2, a light-transmitting decoration of the light-emitting device is provided thereby. With the uniform light source generated by the light-emitting module 2 at the bottom, after the light source penetrates through the thin metal plate 1 with the micropores 11, it cross-diffuses into a lighting area L. The cross fusion of the lighting area L will produce a dark area D between the micropore 11 close to thin metal plate 1 and the other micropore 11. The smaller the spacing distance Y is, the smaller the dark area and the better the light fusion.

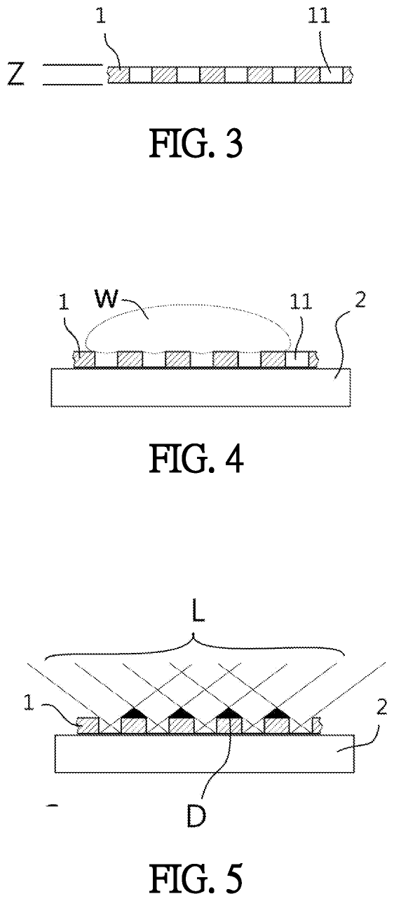

Please cooperate with FIG. 2 and FIG. 3 along together. The present application defines the aperture X of the micropores 11, and the center distance between two adjacent micropores 11 is defined as the spacing distance Y. Corresponds to the thin metal plate 1, the thickness of the thin metal plate 1 is Z, and the relative relationship among them are as follows: Z=0.1˜0.6; X=Z−0.05˜Z+0.05; Y=Z˜Z+0.05 ;

Among them, the dimensions of the thickness Z of the thin metal plate 1, the aperture X of the micropores 11, and the spacing distance Y of the micropores 11 are all in millimeters (mm)

Based on the above-mentioned relative relationship of the size value definitions, specific feasible implementation modes are described as follows:

implementation 1

| Z | X | Y |
|---|---|---|
| 0.1 mm | 0.05~0.15 mm | 0.1~0.15 mm |

As shown from the above table, when the thickness Z of the thin metal plate 1 is set to 0.1 mm, the aperture X of the micropores 11 is between 0.05 to 0.15 mm, and the spacing distance Y of the micropores 11 is between 0.1 to 0.15 mm.

implementation 2

| Z | X | Y |
|---|---|---|
| 0.2 mm | 0.15~0.25 mm | 0.2~0.25 mm |

As shown from the above table, when the thickness Z of the thin metal plate 1 is set to 0.2 mm, the aperture X of the micropores 11 is between 0.15 to 0.25 mm, and the spacing distance Y of the micropores 11 is between 0.2 to 0.25 mm.

implementation 3

| Z | X | Y |
|---|---|---|
| 0.3 mm | 0.25~0.35 mm | 0.3~0.35 mm |

As shown from the above table, when the thickness Z of the thin metal plate 1 is set to 0.3 mm, the aperture X of the micropores 11 is between 0.25 to 0.35 mm, and the spacing distance Y of the micropores 11 is between 0.3 to 0.35 mm.

implementation 4

| Z | X | Y |
|---|---|---|
| 0.4 mm | 0.35~0.45 mm | 0.4~0.45 mm |

As shown from the above table, when the thickness Z of the thin metal plate 1 is set to 0.4 mm, the aperture X of the micropores 11 is between 0.35 to 0.45 mm, and the spacing distance Y of the micropores 11 is between 0.4 to 0.45 mm.

implementation 5

| Z | X | Y |
|---|---|---|
| 0.5 mm | 0.45~0.55 mm | 0.5~0.55 mm |

As shown from the above table, when the thickness Z of the thin metal plate 1 is set to 0.5 mm, the aperture X of the micropores 11 is between 0.45 to 0.55 mm, and the spacing distance Y of the micropores 11 is between 0.5 to 0.55 mm.

implementation 6

| Z | X | Y |
|---|---|---|
| 0.6 mm | 0.55~0.65 mm | 0.6~0.65 mm |

As shown from the above table, when the thickness Z of the thin metal plate 1 is set to 0.6 mm, the aperture X of the micropores 11 is between 0.55 to 0.65 mm, and the spacing distance Y of the micropores 11 is between 0.6 to 0.65 mm

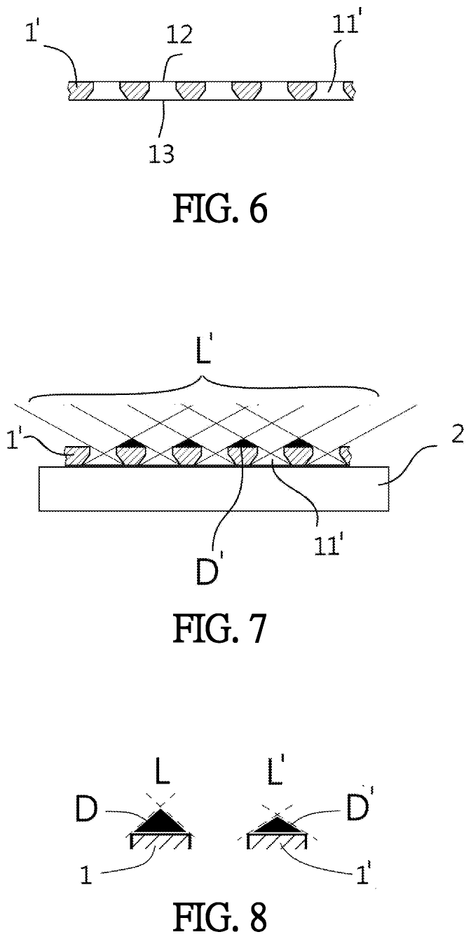

FIG. 6 is a second embodiment of the light-transmitting metal panel with a microporous matrix of the present invention. As shown in the figure, the micropores 11′ made in the thin metal plate 1′ have a lower aperture 13 larger than an upper aperture 12. For example, in one embodiment, during the etching process, the apertures of the photosensitive film on the top and bottom are set to be different. Therefore, it produces micropores 11′ with a small top and a large bottom. In the other word, the micropore 11′ is an inverted cone-shaped pore with a bottom diameter larger than the surface diameter. In an implementation, the preferred ratio of the surface pore size to the bottom pore size of the micropore 11′ is between 1:1.5-2.

As shown in FIG. 7, with this configuration, when the light-emitting module 2 emits light from the bottom of the thin metal plate 1′, the light source penetrates the smaller upper aperture 12 from the larger lower aperture 13 of the micropore 11′, and the diffusion angle of the light zone will be greater than the diffusion angle shown in the first embodiment in FIG. 5. In addition, as shown in the comparison chart in FIG. 8, the generated dark area D′ will also be relatively smaller than the dark area D.

According to the above description, the present application is to provide a light-transmitting metal panel with a microporous matrix. By referring to the dimension definitions of relative values of the thickness Z of the thin metal plate 1, the aperture X of the micropores, and the spacing distance Y of the micropores, it is achieved that the presence of perforations on the metal surface is not easily noticeable, the static moisture is not easy to penetrate through the thin metal plate, and each light spot emitting from the bottom of the micropores matrix pattern 10 can be visually diffused and combined into a flat light pattern by using the special definition of the spacing distance Y.

The above are the preferred embodiments of this application, and the scope of protection of this application is not limited accordingly. Therefore: all equivalent changes made in accordance with the structure, shape, and principle of this application shall be covered by the scope of protection of this application inside.

What is claimed is:

1. A light-transmitting metal panel with a micropores matrix, comprising:
at least one light-transmitting micropore matrix pattern penetrating through a thin metal plate, wherein relative values of a thickness Z of the thin metal plate, an aperture X of the micropores, and a spacing distance Y of the micropores define as Z=0.1˜0.6 mm; X=Z−0.05˜Z+0.05 mm; and Y=Z˜Z+0.05 mm.

2. The light-transmitting metal panel with a micropores matrix of claim 1, wherein the aperture X of the micropores is between 0.05˜0.15 mm, the spacing distance Y of the micropores is between 0.1˜0.15 mm, when the thickness Z of the thin metal plate is set as 0.1 mm.

3. The light-transmitting metal panel with a micropores matrix of claim 1, wherein the aperture X of the micropores is between 0.15˜0.25 mm, the spacing distance Y of the micropores is between 0.2˜0.25 mm, when the thickness Z of the thin metal plate is set as 0.2 mm.

4. The light-transmitting metal panel with a micropores matrix of claim 1, wherein the aperture X of the micropores is between 0.25˜0.35 mm, the spacing distance Y of the micropores is between 0.3˜0.35 mm, when the thickness Z of the thin metal plate is set as 0.3 mm.

5. The light-transmitting metal panel with a micropores matrix of claim 1, wherein the aperture X of the micropores is between 0.35˜0.45 mm, the spacing distance Y of the micropores is between 0.4˜0.45 mm, when the thickness Z of the thin metal plate is set as 0.4 mm.

6. The light-transmitting metal panel with a micropores matrix of claim 1, wherein the aperture X of the micropores is between 0.45˜0.55 mm, the spacing distance Y of the micropores is between 0.5˜0.55 mm, when the thickness Z of the thin metal plate is set as 0.5 mm.

7. The light-transmitting metal panel with a micropores matrix of claim 1, wherein the aperture X of the micropores is between 0.55˜0.65 mm, the spacing distance Y of the micropores is between 0.5˜0.65 mm, when the thickness Z of the thin metal plate is set as 0.6 mm.

8. The light-transmitting metal panel with a micropores matrix of claim 1, wherein the micropore matrix pattern is formed by configuring a plurality of micropores penetrating through the thin metal plate.

9. The light-transmitting metal panel with a micropores matrix of claim 1, wherein the micropore is an inverted cone-shaped pore with a bottom diameter larger than the surface diameter.

10. The light-transmitting metal panel with a micropores matrix of claim 9, wherein a ratio of the surface pore size to the bottom pore size of the micropore is between 1:1.5-2.

11. The light-transmitting metal panel with a micropores matrix of claim 10, a shape of the micropores configured on the thin metal plate is selected from round hole, polygonal hole or special-shaped hole.

12. The light-transmitting metal panel with a micropores matrix of claim 1, a shape of the micropores configured on the thin metal plate is selected from round hole, polygonal hole or special-shaped hole.

13. A light-emitting device, comprising:
a backlight module; and
the light-transmitting metal panel with a micropores matrix of claim 1 for combining with a light-emitting surface of the backlight module.
